(19) United States
(12) Patent Application Publication
(10) Pub. No.: US 2004/0093377 A1
(43) Pub. Date: May 13, 2004

(54) Network system for information creation, management and publication of documentation

(75) Inventors: Jurgen Lumera, Fahrenzhausen (DE); Andreas Struck, Munchen (DE); Christopher J. Folger, Allen Park, MI (US)

Correspondence Address: BAKER & HOSTETLER LLP, Washington Square, Suite 1100, 1050 Connecticut Avenue, N.W., WASHINGTON, DC, 20036, US

(73) Assignee: SPX Corporation

(21) Appl. No.: 10/697,873

(22) Filed: Oct. 31, 2003

Related U.S. Application Data
(60) Provisional application No. 60/422,477, filed on Oct. 31, 2002.

(51) Int. Cl. G06F 15/16

(52) U.S. Cl. 709/203; 715/511

(57) ABSTRACT

The present invention provides an apparatus for a component independent documentation system, which includes a data repository component, a media manager component, and an application server component, wherein the application server component is connected to the data repository, media manager and workflow components.

### PRIORITY

This application claims priority to Provisional U.S. Patent Application entitled “Networkable System For Information Creation, Management and Publication” filed filed Oct. 31, 2002 having Serial No. 60/422,477, the disclosure is hereby incorporated by reference.

### FIELD OF THE INVENTION

The present invention relates generally to a system for information creation, management and publication of documentation. More particularly, the present invention relates to an integrated system for information creation, management and publication of documentation that is independent of the components used in the system.

### BACKGROUND OF THE INVENTION

Over the past few years, many companies have expended considerable resources on the creation, management and publication of documentation. This is at least partially due to the volume of technical documentation that is used in product manufacturing, as well as the considerable volume of information that is necessary to operate and service a given product, be it a toaster oven or an automobile. While a great deal of the creation, management and publication of documentation (hereinafter “the documentation lifecycle”) takes place in electronic form, companies have not realized an increase in efficiency by merely having their information stored electronically.

The adoption and use of electronic authoring, storage and publishing technology has made information available in a variety of new formats in addition to printed publications. Generally, publication of information into an electronic format has improved access to information by making it more immediate. One area where this has taken place is in the area of documentation. An example of this can be appreciated in that it is possible to access documentation such as a VCR user's guide by visiting the VCR manufacturer's website irrespective of the time of day or location of the user. However, the adoption and use of electronic authoring, storage and publication technology as has been done in prior systems, has, in and of itself not provided the ability to effectively manage and control information. Prior documentation systems have and do not provide the ability to create, manage and publish documentation from a single source of information. Additionally, prior documentation systems have not provided the ability effectively to re-use information.

As previously mentioned “the documentation lifecycle” can be described to include the stages of creation, management and publication of information. Previous documentation systems have generally followed one of two approaches. The first approach involves manual coordination between a number of separate applications used at each stage of the documentation cycle. The second approach has been to use an all-in-one documentation system from a single vendor.

The first approach of previous systems involves manual coordination between separate applications used at each stage of the documentation lifecycle. A typical documentation approach may include, technical writers to create/edit information, an information technology (IT) department to handle the management and storage of the information, and a third party to publish the documentation into one or more formats. It is also likely that the technical writers will use one or more applications to create/edit information, the IT department will use one or more different applications to manage and store the information, and the third party will use one or more different applications to publish documentation. It is not likely, however, that any of aforementioned groups will use the same application programs to perform their respective portions of the documentation process. It is also not likely that the software employed will be integrated. There are several drawbacks to the manual coordination approach, even when it is used on a relatively small scale. These drawbacks also make the manual coordination approach extremely difficult to manage even on a small scale.

One drawback of the manual coordination approach is that it is susceptible to document consistency problems. It is often the case that information is created and stored in one format, copied and converted to another format for content management, and copied and converted to yet another format for publication and/or delivery of the information. The result is that information now exists in three different formats and there are three different versions to maintain. Now, whenever part of the documentation is changed, each electronic copy of the documentation must be updated to reflect the change. Maintaining consistency of information in any different versions can be problematic, and depending on the frequency and nature of changes to the information, maintaining consistency is not always feasible.

Under the manual coordination approach of previous systems, in lieu of storing all of the documentation information in a single source, the information is stored in multiple electronic files in multiple electronic formats at any point in the documentation cycle. In many cases, several copies of the same information may be stored in separate incompatible electronic files. Document consistency problems are possible when information comes from multiple sources as opposed to coming from a single source. Multiple sources permit consistency problems to arise at any point in the documentation cycle especially when managing or publishing documentation. Consistency problems may also lead to document version control issues. When multiple copies of a document are not consistent with one anther, multiple copies turn into multiple versions of a document.

The second approach involves an all-in-one documentation system. This second approach also suffers from several drawbacks. One such drawback to the all-in-one approach is that such systems are proprietary, closed systems. An implication of this is that information stored in such a system is not stored in a format that is based on industry standards. Another implication of the all-in-one approach is that there may be little to no interoperability between an all-in-one system and a third party application. This means that it may be quite difficult to import work done in a third party application into a proprietary all-in-one system. Another drawback is that while an all-in-one approach may provide integration of the components in the all-in-one system, the components may not necessarily be the most preferred components to accomplish any one task, much less accomplish one of the stages of the documentation cycle. Thus, the drawback to an all-in-one system that performs some or all of the functions of the documentation lifecycle, is that the all-in-one system may not perform any one task especially well.

Another drawback of prior approaches using an all-in-one documentation system is that a cost associated with adopting and using a proprietary all-in-one system is multi-faceted and is many times expensive. Initially, the cost of license fees to purchase a proprietary system can be expensive. Next, before the system is placed in service, existing documents and other legacy information needs to be converted and imported into the proprietary system. Next, it is likely that one can expect to incur training expenses so existing personnel can use the proprietary system. Even following training, one can expect to encounter a learning curve while existing personnel experience become familiar with the all-in-one system. Next, in the case of a proprietary all-in-one system, there is a cost associated with not being able to re-use existing components that may already be in place. Examples of existing components that are not used with a proprietary system may include XML editors and advanced graphics programs, data repository systems including hardware and software, and programs for used to accomplish publication activities proprietary all-in-one system. This expense can be considerable as it is not uncommon for a business to have existing web servers, database systems, authoring tools, and publication tools which can no longer be used with an all-in-one documentation system. As such, these closed documentation systems tend to be inflexible and do not scale well to adapt to changing needs. Due to the expense involved, the all-in-one approach has not been widely adopted

Another drawback that is common to prior systems is that prior systems do not utilize the content and structure of stored information. Generally, prior systems use a document-centric approach to handling information stored within a system. An implication of this is that, to the extent prior systems manage documents at all, documents are managed as simple objects. A consequence of the document-centric approach of managing simple document objects is that it is not possible to easily reuse information contained in a document, without creating a copy of the original document, and then making a derivative work, another version of the document. As such the same information will exist in a number of different documents and is not maintained or originate from a single source. A limitation of existing documentation systems due to the provision of inadequate document reuse is that existing systems do not provide the ability for the creation, management and publication of technical information from a single source.

Accordingly, it is desirable to provide a system that makes use of existing applications while avoiding the consistency problems of previous approaches. It is also desirable to provide a system that provides integration of existing applications while not incurring the document consistency problems of prior approaches. It is also desirable to provide a system that provides the ability to re-use information contained in the documentation stored in the system. It is also desirable to provide a system that permits the creation, management and publication of information from a single source.

### SUMMARY OF THE INVENTION

The foregoing needs are met, to a great extent, by the present invention, wherein in one aspect an apparatus is provided that in some embodiments the documentation system provides a framework to manage all phases of the information/document creation, management and publishing process using existing applications. Additionally, another embodiment provides the ability to manage and perform the tasks associated with the phases of the documentation lifecycle via a web browser.

In accordance with one embodiment of the present invention a component independent documentation system is provided that includes a workflow component, a data repository component, a media manager component and an application server component. The application server component is connected to the data repository component, the media manager component and the workflow component.

In accordance with another embodiment of the present invention, a component independent documentation system that includes a data repository component having a data repository adapter connected to a data repository interface, a media manager component having a program adapter connected to an media manager interface, a workflow component having a workflow engine adapter connected to a workflow interface and an application server component. The application server component is connected to the data repository component, the media manager component and the workflow component.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of the architecture of a documentation system according to a preferred embodiment of the invention.

FIG. 2 is an illustration of an alternate architecture of a documentation system according to an another preferred embodiment of the invention.

FIG. 3 is an illustration of an alternate architecture of a documentation system according to another preferred embodiment of the invention.

FIG. 4 is an illustration of an alternate architecture of a documentation system according to another preferred embodiment of the invention.

### DETAILED DESCRIPTION

The invention will now be described with reference to the drawing figures, in which like reference numerals refer to like parts throughout. An embodiment in accordance with the present invention provides a framework to manage all phases of the information/document creation, management and publishing process using existing applications. Additionally, an embodiment in accordance with the present invention provides a framework that permits integration of new or existing components such as databases and editors into an integrated documentation system.

One embodiment of the present invention provides an integrated documentation system with a viewer component, an editor, a workflow controller, a media manager. The viewer component enables documents to be viewed on the Internet using a web browser such as Microsoft Internet Explorer, Mozilla or Konqueror. The web browser further includes XML compatibility and support for application plug-ins or helper applications. The editor program is a markup language editor such as a Standard Generalized Markup Language (SGML) or an Extensible Markup Language (XML) editor which is used by authors to create documents based on an integrated customer-specified Document Type Definition (DTD). The workflow controller controls and coordinates review, approval and publication of documentation by authors, editors and illustrators. The media manager integrates new documents into the documentation base and changes the metadata of individual documents. The media manager also supports the upload and download of large amounts of documents.

A documentation system in accordance with the present invention features an abstraction between the system interface and an application specific adapter. Additionally, an embodiment in accordance with the present invention provides the ability to create, manage and publish information from a single source. Also, in accordance with the present invention, in one embodiment, access is provided to all phases of the documentation lifecycle via a web browser.

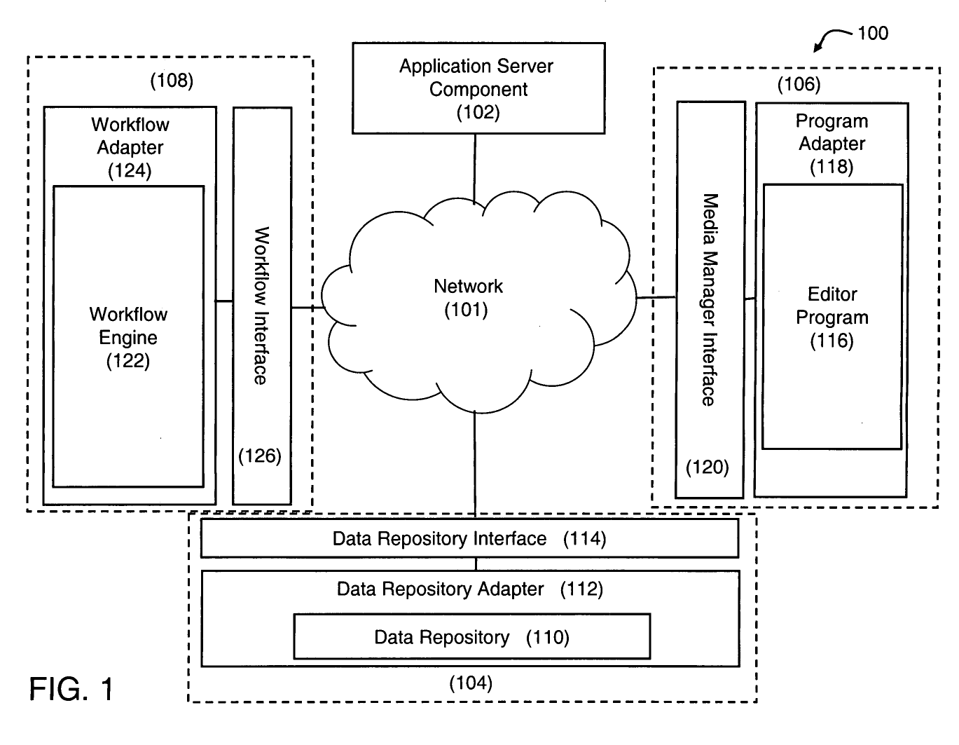

An embodiment of the present inventive system and method is illustrated in FIG. 1. FIG. 1 includes a documentation system 100 with a network 101 connected to an application server component 102, a data repository component 104, a media manager component 106, and a workflow component 108. While FIG. 1 shows components connected using a network 101, it should be understood that the documentation system components may reside on the same computer. A computer should be broadly construed to mean any device capable of processing or accessing information such as a pc, server, mini-computer, workstation, personal digital assistant (PDA) or terminal.

The data repository component 104 includes one or more data repositories 110, a data repository adapter 112 and a data repository interface 114. The data repository 110 is connected to a data repository adapter 112 which is connected to the data repository interface 114. Communications to and from the data repository component 104 are occur via the data repository interface 114.

The data repository adapter 112 links the data repository 110 to the data repository interface 114. The data repository adapter 112 supplies implementation of the data repository interface 114 and implements the functionalities required by deploying appropriate mapping onto the potential of the actual data repository 110. In addition to the actual mapping of the functionality, the documents and metadata into and out of the documentation system are translated into the corresponding data repository 110 representations. The repository adapter 112 enables any functionalities not present in the data repository 110 to be supplied by implementing them as appropriate, or enables persistence maintenance to be distributed among a number of systems which then take on the “external” form of a single system.

To optimize adaptation to individual tasks, the adapter definition involves registering specific handlers that support data transformation for both read and write operations. An example of a handler may utilize extensible Style Language (XSL). The adapter can be used by instancing an Enterprise JavaBean (EJB) or native use of a Java library within another module of another application. Using this method, access to the repository can be integrated almost invisibly into existing applications, which then appear as part of the overall documentation creation process.

The media manager component 106 includes one or more programs 116, a program adapter 118, and a media manager interface 120. The media manager component 106 includes one or more programs 116 such as an SGML/XML editor program, a word processor, or a graphical illustration program. The program adapter 118 connects one or more programs 116 to the media manager interface 120. The program adapter 118 serves as a link between the media manager interface 120 and one or more application programs 116. Communications to and from the media manager component 106 are occur via the media manager interface 120. The media manager component 106 is connected to the application server component 102 via the media manager interface 120.

The media manager component 106 is used when data is written into or read from the data repository component 104. Additionally, the media manager component 106 is used when a functionality requiring user input is needed. The media manager component 106 supplies the user interface with the documentation system and provides services as a standalone application and supply dedicated functions when they are requested by other system modules. The provision of this function is desirable should a non-Java enabled application need to be integrated using a Java-component object model (COM) bridge. The media manager component 106 creates the correct instance of the data repository adapter 112 and supplying it with appropriate values, such as the user id and IP address. Additionally the media manager component 106 supplies the interface to the workflow component 108 for providing workflow information.

The workflow component 108 includes one or more workflow engines 122, a workflow engine adapter 124 and a workflow interface 126. The workflow component 108 controls the document processing sequence, supplying a controlled environment for document changes, review, approval and publication. Additionally, the workflow component 108 serves to coordinate processing of the documentation as a whole by authors, editors and illustrators thus preventing documents undergoing processing from being accessed by other authors. The workflow engine adapter 124 connects one or more workflow engines 122 to the workflow interface 126. The workflow component 108 is connected to the application server component 102 via the workflow interface 126.

The network 101 may be a distributed network which may be implemented as an intranet, a local area network (LAN), or a wide area network (WAN) such as the Internet. Additionally, the network 101 may also be the medium used to provide communications links between network connected devices and may include switches, routers, hubs, wired connections, wireless communication links, or fiber optic cables. The application server component 102 may include one or more computers which may store one or more components of the documentation system. Additionally, the application server component 102 may also provide a web based graphical user interface to access one or more of the documentation system components. The application server component 102 may also include various web applications including a document viewers. According to one embodiment of the invention, the application server component 102 is implemented using the current JBoss-2.4.3_Tomcat-3.2.3 combined with SUN Java Development Kit 1.3.1.

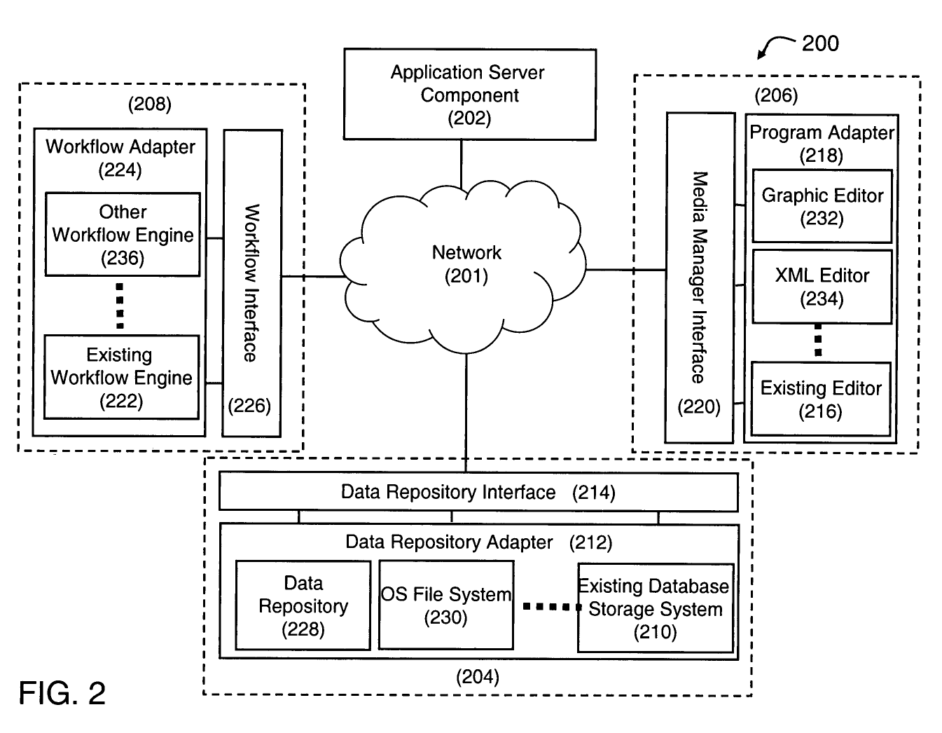

Another embodiment of the present inventive system and method is illustrated in FIG. 2. FIG. 2 includes a documentation system 200 with a network 201 connected to an application server component 202, a data repository component 204, a media manager component 206, and a workflow component 208. The data repository component 204 includes one or more data repositories such as an existing database storage system 210, a data repository 228 and an operating system (OS) file system 230. The data repository component further includes a data repository adapter 212 and a data repository interface 214. The media manager component 206 includes one or more programs such as an existing editor application 216, a graphic editor 232, and an XML editor 234. The media manager component 206 further includes a program adapter 218 and a media manager interface 220. The workflow component 208 includes one or more workflow engines such as an existing workflow system 222 or a workflow system from a different vendor 236, as well as a workflow adapter 224 and a workflow interface 226.

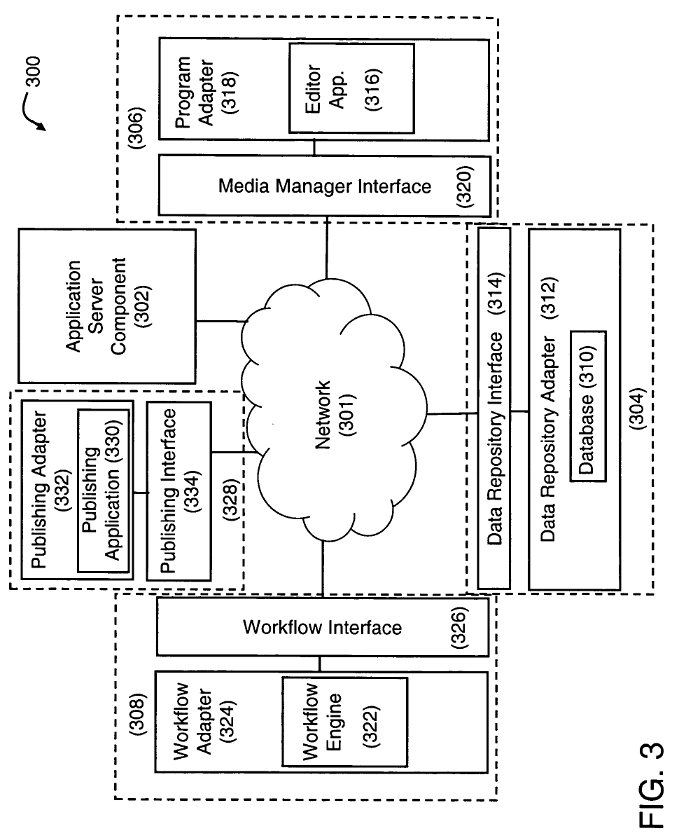

Another embodiment of the present inventive system and method is illustrated in FIG. 3. FIG. 3 includes a documentation system 300 with a network 301 connected to an application server component 302, a data repository component 304, a media manager component 306, a workflow component 308 and a publishing component 328. The data repository component 304 includes one or more databases 310, a data repository adapter 312 and a data repository interface 314. The media manager component 306 includes one or more programs 316, a program adapter 318 and a media manager interface 320. The workflow component 308 includes one or more workflow engines 322, a workflow adapter 324 and a workflow interface 326. The publishing component 328 includes one or more publishing applications 330, a publishing adapter 332 and a publishing interface 334.

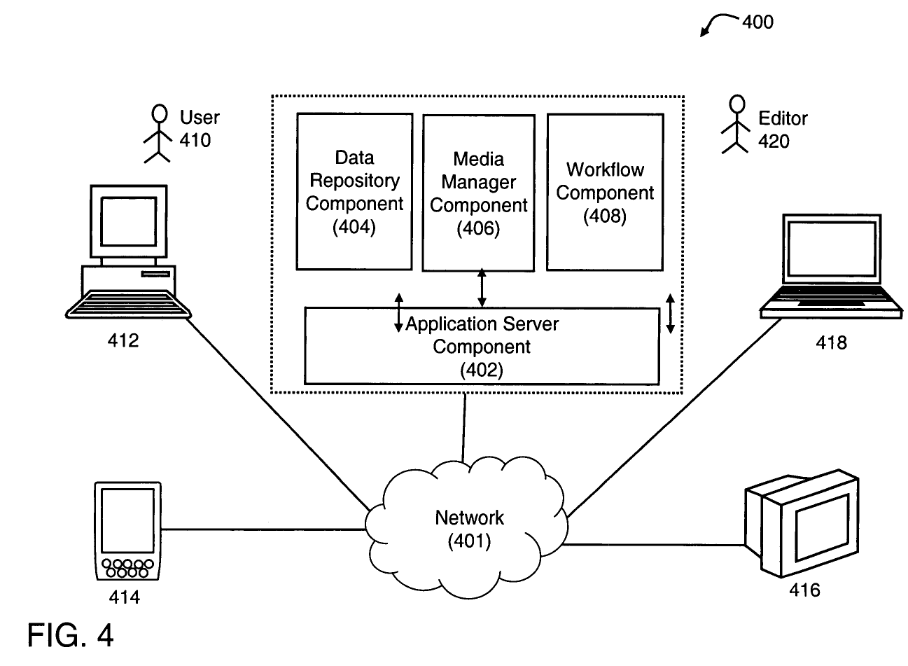

Another embodiment of the present inventive system and method is illustrated in FIG. 4. FIG. 4 includes a documentation system 400 with a network 401 connected to an application server 402. The application server 402 includes a data repository component 404, a media manager component 406, and a workflow component 408. It should be understood that the application server 402 may include one or more machines which may store one or more components of the documentation system. A end user 410 may access the application server 402 to view documentation via a device that is connected to the network 401 where the device is running a viewer application such as a web browser. Examples of network connected devices include a computer 412, personal digital assistant (PDA) 414, kiosk 416 or portable computer 418. An editor user 420 may access the application server 402 to edit documentation a network connected device, such as those described above. The editor user 420 may also access the application server 402 to edit documentation using a third party application such as an XML editor.

By way of example, the editor user 420 uses an editing program on portable computer 418 to create a new document. Once the editor user 420 has created the document, the editor user 420 uses portable computer 418 to connect to application server component 402 via network 401. Once connected to the application server component 402, the editor user 420 uses the media manager component 406 to add and import the document into the system. The media manager component 406 generates document data and document metadata by separating the content of the document from the formatting and presentation of the document. The media manager component 406 stores the document data and document metadata by using the data repository component 404.

According to one embodiment of the present invention, the method is implemented as a computer program, namely, as a set of instructions executed by a processor. Thus, for example, the method may be a Java applet, a browser plug-in, a standalone application written in native code, a distinct process built into the web browser, or part of the integral web browser functionality. One of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A component independent documentation system, comprising:
a workflow component;
a data repository component;
a media manager component; and
an application server component, wherein said application server component is connected to said data repository component, said media manager component and said workflow component.

2. The system of claim 1, wherein said data repository component further comprises:
a data repository adapter; and
a data repository interface, wherein said repository interface is connected to said data repository adapter and said application server component.

3. The system of claim 1, wherein said data repository component further comprises:
one or more data repositories;
a data repository adapter, wherein said data repository adapter is connected to said one or more data repositories; and
a data repository interface, wherein said repository interface is connected to said data repository adapter and said application server component.

4. The system of claim 1, wherein said media manager component further comprises:
a program adapter; and
a media manager interface, wherein said media manager interface is connected to said program adapter and said application server component.

5. The system of claim 1, wherein said media manager component further comprises:
one or more programs;
a program adapter, wherein said program adapter is connected to said one or more programs; and
a media manager interface, wherein said media manager interface is connected to said program adapter and said application server component.

6. The system of claim 1, wherein said workflow component further comprises:
a workflow engine adapter; and
a workflow interface, wherein said workflow interface is connected to said workflow engine adapter and said application server component.

7. The system of claim 1, wherein said workflow component further comprises:
one or more workflow engines;
a workflow engine adapter, wherein said workflow engine adapter is connected to said one or more workflow engines; and
a workflow interface, wherein said workflow interface is connected to said workflow engine adapter and said application server component.

8. The system of claim 1, wherein said data repository component further comprises:
one or more data repositories;
a data repository adapter, wherein said data repository adapter is connected to said one or more data repositories; and
a data repository interface, wherein said repository interface is connected to said data repository adapter and said application server component.

9. The system of claim 1, wherein said media manager component further comprises:
one or more programs;
a program adapter, wherein said program adapter is connected to said one or more programs; and
a media manager interface, wherein said media manager interface is connected to said program adapter and said application server component.

10. The system of claim 1, wherein said workflow component further comprises:
one or more workflow engines;
a workflow engine adapter, wherein said workflow engine adapter is connected to said one or more workflow engines; and
a workflow interface, wherein said workflow interface is connected to said workflow engine adapter and said application server component.

11. The system of claim 1, further comprising:
a publishing component, wherein said publishing component is connected to said application server component.

12. The system of claim 1, further comprising:
a publishing component, comprising:
a publishing adapter; and
a publishing interface, wherein said publishing interface is connected to said publishing adapter and said application server component.

13. The system of claim 1, further comprising:
a publishing component, comprising:
one or more publishing applications;
a publishing adapter, wherein said publishing adapter is connected to said one or more publishing applications; and
a publishing interface, wherein said publishing interface is connected to said publishing adapter and said application server component.

14. A component independent documentation system, comprising:
a data repository component having a data repository adapter connected to a data repository interface;
a media manager component having a program adapter connected to an media manager interface;
a workflow component having a workflow engine adapter connected to a workflow interface; and
an application server component, wherein said application server component is connected to said data repository component, said media manager component and said workflow component.

15. The system of claim 14, further comprising:
a publishing component, wherein said publishing component is connected to said application server component.

16. The system of claim 14, further comprising:
a publishing component, comprising:
a publishing adapter; and
a publishing interface, wherein said publishing interface is connected to said publishing adapter and said application server component.

17. A component independent documentation system, comprising:
one or more data repositories;
a data repository adapter, wherein said data repository adapter is connected to said one or more data repositories; and
a data repository interface, wherein said repository interface is connected to said data repository adapter and said application server component. one or more programs;
a program adapter, wherein said program adapter is connected to said one or more programs; and
a media manager interface, wherein said media manager interface is connected to said program adapter and said application server component.
one or more workflow engines;
a workflow engine adapter, wherein said workflow engine adapter is connected to said one or more workflow engines; and
a workflow interface, wherein said workflow interface is connected to said workflow engine adapter and said application server component.

18. The system of claim 17, further comprising:
a publishing component, comprising:
one or more publishing applications;
a publishing adapter, wherein said publishing adapter is connected to said one or more publishing applications; and
a publishing interface, wherein said publishing interface is connected to said publishing adapter and said application server component.
